(19) United States
(12) Patent Application Publication
(10) Pub. No.: US 2021/0370401 A1
(43) Pub. Date: Dec. 2, 2021

(54) A 3-D PRINTING METHOD AND A 3-D PRINTOUT

(71) Applicant: Siemens Aktiengesellschaft, Muenchen (DE)

(72) Inventors: Chang Peng LI, Beijing (CN); Zhong Jiao ZHOU, Beijing (CN); Guo Feng CHEN, Beijing (CN)

(73) Assignee: Siemens Aktiengesellschaft, Muenchen (DE)

(21) Appl. No.: 17/272,716

(22) PCT Filed: Sep. 3, 2019
(86) PCT No.: PCT/EP2019/073466

§ 371 Date: Mar. 2, 2021

(30) Foreign Application Priority Data
Sep. 4, 2018 (CN) 201811028076.X

(51) Int. Cl. B22F 10/28; B22F 10/322; B22F 12/41; B22F 10/73; B33Y 10/00; B33Y 80/00

(52) U.S. Cl. CPC B22F 10/28; B22F 10/322; B22F 12/41; B22F 2201/02; B33Y 10/00; B33Y 80/00; B22F 2201/11; B22F 10/73

(57) ABSTRACT

A 3-D printing method and a 3-D printout are provided. In an embodiment, the 3-D printing method includes laser-scanning a printing material according to a 3-D printing model so that the printing material starts to be sintered into a printout in a shape, layer by layer from the bottom up; and feeding a treatment gas into a 3-D printing device and laser-scan a local area of the printout so that the treatment gas reacts with the surface of the local area of the printout and a hardened layer is formed. The laser scanning and the feeding of the treatment gas are performed alternately until a printout with local hardened layers is formed. By adjusting the gas environment, the components can be manufactured by selective laser melting equipment to have a wear- and corrosion-resistant nitrided surface layer and keep the expected ductility of the central area.

### PRIORITY STATEMENT

This application is the national phase under 35 U.S.C. § 371 of PCT International Application No. PCT/EP2019/073466 which has an International filing date of Sep. 3, 2019, which designated the United States of America and which claims priority to Chinese patent application number CN 201811028076.X filed Sep. 4, 2018, the entire contents of each of which are hereby incorporated herein by reference.

### FIELD

Embodiments of the invention generally relate to the field of additive manufacturing, and in particular relates to a 3-D printing method and a 3-D printout.

### BACKGROUND

Additive manufacturing is now one of the world's fastest growing advanced manufacturing technologies, showing a wide application prospect. Selected laser melting (SLM) is one of the additive manufacturing technologies which can quickly manufacture the parts which are the same as a computer aided design (CAD) model by means of laser sintering. Currently, selected laser melting has been applied widely. Different from the traditional material removal mechanism, additive manufacturing is based on the completely opposite material incremental manufacturing philosophy, wherein selected laser melting utilizes a high-power laser to melt metal powder and builds components layer by layer by means of 3-D CAD input, and in this way, components with complex internal channels can be manufactured successfully. Additive manufacturing technologies can provide a unique potential of arbitrarily manufacturing complex components, which cannot be easily manufactured by use of a traditional manufacturing process.

Despite the above-mentioned advantages of additive manufacturing, a high capital investment and a low printing rate hinder additive manufacturing from being applied widely. Based on cost considerations, additive manufacturing technologies are more suitable than traditional manufacturing technologies for components with a customized design, a low production quantity and a complex structure. A typical application of additive manufacturing is to manufacture sealing components.

### SUMMARY

The inventors have discovered that additive manufacturing technologies still have some technical bottlenecks, for example, a relatively low corrosion resistance and wear resistance. To solve the above-mentioned problems, a high-loss material, for example, a carbide material, is selected for sealing components in the prior art. The inventors have discovered that it is difficult to use a carbide material in an additive manufacturing process because cracks in the material are easily caused by fast laser heating and cooling. The binder jetting technology can be used to manufacture hard metal components if a sintering process is performed after binder jetting. The inventors have discovered that it is not easy to predict or control the high shrinkage rate during sintering. This hinders the application of the binder jetting technology to sealing components with a high dimensional accuracy.

In a first embodiment, the present invention provides a 3-D printing method, wherein the 3-D printing method comprises the following steps: S1. laser-scan a printing material according to a 3-D printing model so that the printing material starts to be sintered into a printout in the preset shape layer by layer from the bottom up; S2. feed a treatment gas into a 3-D printing device and laser-scan a local area of the printout so that the treatment gas reacts with the surface of the local area of the printout and a hardened layer is formed, wherein the step S1 and the step S2 are performed alternately until a printout with local hardened layers is formed.

In a second embodiment, the present invention provides a 3-D printout, wherein the 3-D printout is manufactured by use of the 3-D printing method provided in the first embodiment of the present invention.

### BRIEF DESCRIPTION OF THE DRAWINGS

FIG. 1 is a schematic diagram of selected laser melting equipment.

FIG. 2a is a cross-sectional view of a 3-D printout formed by carrying out the 3-D printing method in selected laser melting equipment in a specific embodiment of the present invention, wherein the 3-D printout has a hardened layer on the upper and lower surfaces, respectively.

FIG. 2b is a cross-sectional view of a 3-D printout formed by carrying out the 3-D printing method in selected laser melting equipment in another specific embodiment of the present invention, wherein the 3-D printout has spaced hardened layers.

FIG. 2c is a cross-sectional view of a 3-D printout formed by carrying out the 3-D printing method in selected laser melting equipment in a further specific embodiment of the present invention, wherein the 3-D printout has a hardened layer in the central area.

### DETAILED DESCRIPTION OF THE INVENTION

In a first embodiment, the present invention provides a 3-D printing method, wherein the 3-D printing method comprises the following steps: S1. laser-scan a printing material according to a 3-D printing model so that the printing material starts to be sintered into a printout in the preset shape layer by layer from the bottom up; S2. feed a treatment gas into a 3-D printing device and laser-scan a local area of the printout so that the treatment gas reacts with the surface of the local area of the printout and a hardened layer is formed, wherein the step S1 and the step S2 are performed alternately until a printout with local hardened layers is formed.

Further, the treatment gas includes ammonia.

Further, in an embodiment the 3-D printing method further comprises the following step: perform the step S1 and the step S2 alternately until a printout with spaced hardened layers is formed so that the printout has the expected hardness.

Further, in an embodiment the 3-D printing method further comprises the following step: adjust the internal elastic modulus and surface hardness of the printout by adjusting the volume ratio between the material layer and hardened layers of the printout.

Further, in an embodiment the 3-D printing method further comprises the following step: adjust the internal elastic modulus and surface hardness of the printout by adjusting the amounts and transport time of the treatment gas and protective gas and the thicknesses of the material layer and hardened layers.

Further, in an embodiment the laser-scanning step comprises rotary laser-scanning or local laser-scanning.

Further, in an embodiment a protective gas is fed into the 3-D printing device when the step S1 is performed, wherein the protective gas is an inert gas.

Further, in an embodiment the protective gas includes nitrogen or argon.

Further, in an embodiment the 3-D printing method further comprises the following step: feed the printing material forming the material layer from the 3-D printing device into a recovery cylinder to recover the printing material.

In a second embodiment, the present invention provides a 3-D printout, wherein the 3-D printout is manufactured by use of the 3-D printing method provided in the first embodiment of the present invention.

By adjusting the gas environment, an embodiment of the present invention enables the components manufactured by selected laser melting equipment to have a wear- and corrosion-resistant nitrided surface layer and keep the expected ductility of the central area, wherein the nitrided layer has an ideal lattice structure. In addition, no additional surface treatment is required for the present invention, and therefore, the power consumption and the cost are lower. The in-situ nitridation process provided by the present invention precisely controls the nitridation gradient.

Specific embodiments of the present invention will be described below in combination with the drawings.

An embodiment of the present invention provides a 3-D printing method, wherein the laser-scanning step and the hardening step are simultaneously performed in a 3-D printing device to form a 3-D printout with arbitrarily local hardened layers. In addition, compared with separate nitridation treatment, the hardness gradient and depth of the hardened layers formed in the present invention can be adjusted accurately so that an overhardened surface layer can be avoided when a sufficient hardened depth is achieved. Therefore, no overhardened layer removal step is required, local hardened layers are not readily able to crack and the hardness can be adjusted as required.

An embodiment of the present invention is preferably carried out in selected laser melting equipment, wherein different printing materials such as metals, ceramic, plastic and sand are provided in selected laser melting equipment. In the following description of the present invention, metal powder is used as a printing material.

By adjusting the gas environment, the present invention enables the components manufactured by selected laser melting equipment to have a wear- and corrosion-resistant nitrided surface layer and keep the expected ductility of the central area, wherein the nitrided layer has an ideal lattice structure. In addition, no additional surface treatment is required for the present invention, and therefore, the power consumption and the cost are lower. The in-situ nitridation process provided by the present invention precisely controls the nitridation gradient.

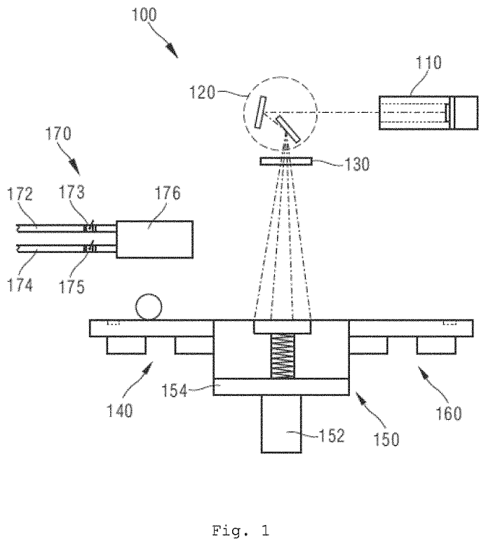

FIG. 1 is a schematic diagram of selected laser melting equipment. As shown in FIG. 1, selected laser melting equipment (100) comprises a laser source (110), a mirror face scanner (120), a prism (130), a powder feeding cylinder (140), a formation cylinder (150) and a recovery cylinder (160). The laser source (110) is arranged on the top of the selected laser melting equipment (100) and is used as a heating source of metal powder, namely, melt metal powder for 3-D printing.

A first piston (not shown) which can move up and down is provided in the lower part of the powder feeding cylinder (140), spare metal powder is placed in the chamber space above the first piston in the powder feeding cylinder (140), and metal powder is fed from the powder feeding cylinder (140) into the formation cylinder (150) as the first piston moves up and down. A 3-D printout placement table (154) is arranged in the formation cylinder (150), a 3-D printout (C) is held above the placement table (154), and a second piston (152) is fixed below the placement table (154), wherein the second piston (152) is perpendicular to the placement table (154). During 3-D printing, the second piston (152) moves from the top down to form a printing space in the formation cylinder (150). The laser source (110) for laser scanning should be arranged above the formation cylinder (150) of the selected laser melting equipment. The position of the laser is adjusted by adjusting the angle of the prism (130) and the mirror face scanner (120) determines the area in which the metal powder will be scanned through the adjustment of the prism (130). The powder feeding cylinder (140) further comprises a roller (not shown), metal powder (P) is piled on the upper surface of the first piston, and the first piston moves vertically from the bottom up to transport metal powder to the top of the powder feeding cylinder (140). The roller can roll over metal powder (P) to transport metal powder (P) into the formation cylinder (150). Thus, metal powder is continuously scanned by a laser and metal powder is decomposed into powder matrices. The powder matrices are again scanned by a laser until the powder matrices are sintered into a printout (C) in the preset shape layer by layer from the bottom up.

The selected laser melting equipment (100) further comprises a gas supply device (170). The gas supply device (170) comprises a first gas inlet pipeline (172), a second gas inlet pipeline (174) and a gas outlet pipeline (176), wherein a first valve (173) is arranged in the first gas inlet pipeline (172), and a second valve (175) is arranged in the second gas inlet pipeline (174). A control device (171) is connected to the first valve (173) and the second valve (175) and is used to control the opening and closing of the first gas inlet pipeline (172) and the second gas inlet pipeline (174).

The 3-D printing method provided in the present invention comprises the following steps:

Step S1: Laser-scan a printing material according to a 3-D printing model so that the printing material starts to be sintered into a printout in the preset shape layer by layer from the bottom up, wherein according to a preferred embodiment of the present invention, the 3-D printing module is a digital model and the printing material is metal powder. Specifically, laser-scan metal powder continuously to decompose metal powder into powder matrices, and continue to laser-scan the powder matrices until the powder matrices are sintered into a printout in the preset shape layer by layer from the bottom up. At the time of laser-scanning, open the first valve (173) in the first gas inlet pipeline (172) to transport a protective gas into the selected laser melting equipment (100). Meanwhile, close the second valve (175) in the second gas inlet pipeline (174) to cut off the supply of ammonia (NH3) to the selected laser melting equipment (100), and thus the protective gas environment for laser-scanning is formed.

Step S2: Feed a treatment gas into a 3-D printing device and laser-scan a local area of the printout so that the treatment gas reacts with the surface of the local area of the printout and a hardened layer is formed, wherein according to a preferred embodiment of the present invention, the 3-D printing device is the selected laser melting equipment (100) shown in FIG. 1. Specifically, as shown in FIG. 1, the first gas inlet pipeline (172) is used to transport a protective gas, and the second gas inlet pipeline (174) is used to transport a treatment gas. Particularly, the protective gas is an inert gas, for example, nitrogen or argon. The treatment gas is ammonia (NH3). When it is necessary to form local hardened layers or local hardened areas based on a 3-D printing model, close the first valve (173) in the first gas inlet pipeline (172) to cut off the transport of the protective gas into the selected laser melting equipment (100). In addition, open the second valve (175) in the second gas inlet pipeline (174) to let the treatment gas ammonia (NH3) enter the selected laser melting equipment (100). Ammonia (NH3) close to the formation cylinder (150) will be decomposed into ions to react with the metallic material and the ions decomposed from ammonia (NH3) diffuse to react with the metallic material of the printout to form a thin hardened layer.

The step S1 and the step S2 are performed alternately until a 3-D printout with local hardened layers is formed. The 3-D printing method provided in the present invention is described below in combination with different printout shapes/structures.

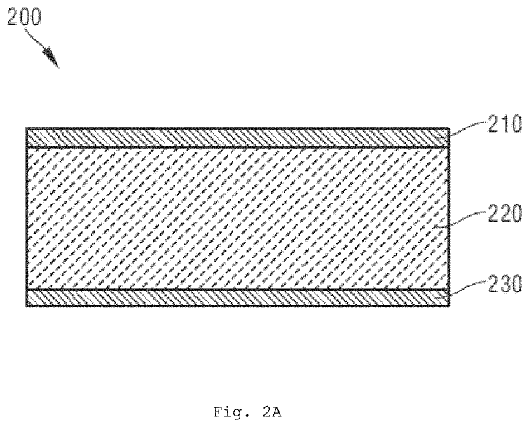

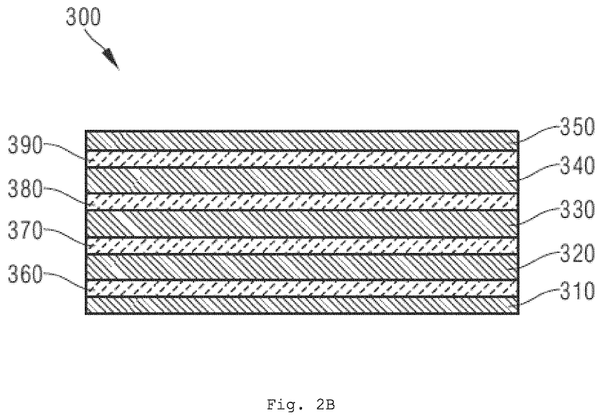

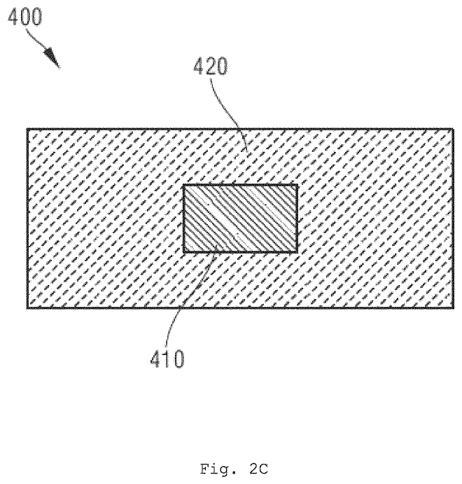

As shown in FIG. 2a, according to the digital model, the first 3-D printout (200) should have a metal body (220), and the upper and lower surfaces of the metal body (220) should respectively be equipped with a hardened layer, namely, a first hardened layer (210) on the upper surface of the metal body (220) and a second hardened layer (230) on the lower surface of the metal body (220). The arrow direction in FIG. 2a indicates the printing direction, namely, the direction of printing vertically from the bottom up. Specifically, first perform the hardening step S2 to print the second hardened layer (230). At this time, open the second valve (175) in the second gas inlet pipeline (174) to permit the treatment gas ammonia (NH3) to enter the selected laser melting equipment (100). Meanwhile, close the first valve (173) in the first gas inlet pipeline (172) to cut off the supply of the protective gas into the selected laser melting equipment (100). After the second hardened layer (230) is formed, start to perform the laser-scanning step S1. Specifically, open the first valve (173) in the first gas inlet pipeline (172) to transport the protective gas into the selected laser melting equipment (100). Meanwhile, close the second valve (175) in the second gas inlet pipeline (174) to cut off the supply of the treatment gas ammonia (NH3) to the selected laser melting equipment (100). After the metal body (220) is formed, start to perform the hardening step S2 to print the first hardened layer (210). At this time, open the second valve (175) in the second gas inlet pipeline (174) to permit the treatment gas ammonia (NH3) to enter the selected laser melting equipment (100). Meanwhile, close the first valve (173) in the first gas inlet pipeline (172) to cut off the supply of the protective gas into the SLM equipment (100). Perform the laser-scanning step S1 and the hardening step S2 alternately until the first 3-D printout (200) is formed.

An embodiment of the present invention further comprises the following step: perform the step S1 and the step S2 alternately until a printout with spaced hardened layers is formed so that the printout has the expected hardness.

As shown in FIG. 2b, according to the digital model, a second 3-D printout (300) has spaced hardened layers. Specifically, the second 3-D printout (300) has a first hardened layer (310), a first material layer (360), a second hardened layer (320), a second material layer (370), a third hardened layer (330), a third material layer (380), a fourth hardened layer (340), a fourth material layer (390) and a fifth hardened layer (350). According to a variant embodiment of the embodiment shown in FIG. 2a, perform the laser-scanning step S1 and the hardening step S2 alternately a number of times. The arrow direction in FIG. 2b indicates the printing direction, namely, the direction of printing vertically from the bottom up. Specifically, first perform the hardening step S2 to print the first hardened layer (310). At this time, open the second valve (175) in the second gas inlet pipeline (174) to permit the treatment gas ammonia (NH3) to enter the selected laser melting equipment (100). Meanwhile, close the first valve (173) in the first gas inlet pipeline (172) to cut off the supply of the protective gas into the selected laser melting equipment (100). After the first hardened layer (310) is formed, start to perform the laser-scanning step S1. Specifically, open the first valve (173) in the first gas inlet pipeline (172) to transport the protective gas into the selected laser melting equipment (100). Meanwhile, close the second valve (175) in the second gas inlet pipeline (174) to cut off the supply of the treatment gas ammonia (NH3) to the selected laser melting equipment (100). Again, perform the hardening step S2 and the laser-scanning step S1 alternately a number of times, and thus the second hardened layer (320), the second material layer (370), the second hardened layer (330), the third material layer (380), the fourth hardened layer (340), the fourth material layer (390) and the fifth hardened layer (350) are formed in turn until the second 3-D printout (300) is formed.

As shown in FIG. 2c, according to the digital model, a third 3-D printout (400) has a material area (420) and a hardened area (410) at the center of the material area (420). A local scanning policy needs to be adopted in the present embodiment. Specifically, first perform laser-scanning vertically from the bottom up according to the printing direction indicated by the arrow in FIG. 2c, that is to say, perform the laser-scanning step S1 to form a material area (420) with a preset thickness. Then, form a hardened area (410) at the center of the material area (420), that is to say, perform the hardening step S2. When performing the laser-scanning step S1, open the first valve (173) in the first gas inlet pipeline (172) to transport the protective gas into the selected laser melting equipment (100). Meanwhile, close the second valve (175) in the second gas inlet pipeline (174) to cut off the supply of the treatment gas ammonia (NH3) to the selected laser melting equipment (100). When performing the hardening step S2, open the second valve (175) in the second gas inlet pipeline (174) to permit the treatment gas ammonia (NH3) to enter the selected laser melting equipment (100). Meanwhile, close the first valve (173) in the first gas inlet pipeline (172) to cut off the supply of the protective gas into the selected laser melting equipment (100).

In addition, an embodiment of the present invention further comprises the following step: feed the printing material forming the material layer from the formation cylinder of the 3-D printing device into the recovery cylinder to recover the printing material. In the present embodiment, the metal powder forming the material area (420) can be recovered for use. Specifically, as shown in FIG. 1, after printing is completed, the second piston (152) below the placement table (154) in the formation cylinder (150) moves vertically from the bottom up to transport the remaining metal powder into the recovery cylinder (160).

The laser-scanning step comprises rotary laser-scanning or local laser-scanning.

An advantage of at least one embodiment of the present invention lies in that the internal elastic modulus and the surface hardness of a printout can be adjusted. Alternatively, the internal elastic modulus and surface hardness of the printout can be adjusted by adjusting the volume ratio between the material layer and hardened layers of the printout. Alternatively, the internal elastic modulus and surface hardness of the printout can be adjusted by adjusting the amounts and transport time of the treatment gas and protective gas and the thicknesses of the material layer and hardened layers.

When step S2 is performed, under the action of a laser, ammonia (NH3) is decomposed:

NH₃→[N]Fe+ 3/2H

Specifically, when step S2 is performed, the heat caused by laser-scanning decomposes ammonia (NH3) into atomic nitrogen (N) and hydrogen (H), and atomic nitrogen (N) and hydrogen (H) will perform a nitridation treatment on the surface of the printout. If the material of the printout is steel, a wear- and corrosion-resistant compound layer will be formed on the surface of the steel.

Ammonia (NH3) is decomposed into atomic nitrogen (N) and hydrogen (H) under the action of laser when step S2 is performed.

Nitrogen (N) atoms penetrating into steel react with iron in the steel to form nitrided iron with different nitrogen contents on the one hand, and react with alloy elements in the steel to form various alloy nitrides, in particular, aluminum nitride and chromium nitride, on the other hand.

In addition, a mixture of NH3 and CO2 can be fed in the present invention so that a thermal decomposition reaction can take place between the mixture of NH3 and CO2 and the surface of the steel to generate active carbon and nitrogen atoms. Active carbon and nitrogen atoms are absorbed by the surface of the printout and are penetrated into the surface of the printout through diffusion. Thus, a carbon-nitrogen co-penetrated layer where the nitrogen content is greater than the carbon content is obtained, and higher hardness and material ductility are obtained.

The thickness of the compound layer is about 0.05 mm to 1.0 mm, and in addition, the compound layer is extremely hard, with a hardness of 1000 HV to 1200 HV.

In a second embodiment, the present invention provides a 3-D printout, wherein the 3-D printout is manufactured by use of the above-mentioned 3-D printing method.

Compared with the prior art, nitridation treatment in the prior art is combined with 3-D printing. The hardened layer formed through nitridation treatment has a high hardness gradient, that is to say, the outermost surface is an overhardened layer, and a decreasing hardness gradient exists from the overhardened layer to the material layer. In this case, the overhardened layer on the outer surface will crack or become fragile because the hardness is too high. Therefore, mechanical treatments such as surface polishing need to be performed to polish off or remove the overhardened layer after 3-D printing. It is difficult to control the gradient effect of the hardened layer formed after the nitridation treatment of the prior art. In addition, mechanical treatments such as surface polishing make the process complicated. One-piece formation is the advantage of 3-D printing and a complicated process weakens the advantage. In addition, mechanical treatments such as surface polishing cannot be performed for some 3-D printouts. These printouts have complicated internal structures or have surface voids and the sizes are changed after surface polishing.

The nitridation process is performed in the 3-D printing of the present invention and the degree of nitridation is controlled by precisely controlling the mixing ratio between the inert gas and the treatment gas ammonia (NH3). The nitridation gradient of components manufactured by use of selected laser melting can be easily controlled and a thick nitrided layer where the surface is not extremely nitrided can be obtained. In addition, the implementation of the nitridation process can guarantee that components have a hard surface layer and a ductile central area. Components with nitrided interlayers and different lattice structures can also be guaranteed to have high wear resistance and a satisfactory ductility.

At least one embodiment of the present invention is applicable not only to the in-situ nitridation process in selected laser melting, but also to other treatments involving a printing gas environment. Since the nitridation process only happens near the formation cylinder where the treatment gas ammonia (NH3) has a high enough temperature, the other metal powder will not be influenced and will be well recycled to guarantee a utilization ratio of the untreated powder material.

Although the above-mentioned embodiments have described the content of the present invention in detail, the description above should not be considered as a restriction of the present invention. Upon reading the content above, various modifications and replacements to the present invention will become obvious to those skilled in the art. Therefore, the scope of protection of the present invention should be defined by the attached claims. In addition, any reference numeral in the claims should not be considered as a restriction of the claims, the term “comprise” does not exclude the devices or steps not listed in other claims or the description, and the terms “first” and “second” are only used to represent a name, and not to represent any specific sequence.

4658001.1

1. A 3-D printing method, comprising:
laser-scanning a printing material in a 3-D printing model such that the printing material starts to be sintered into a printout into a shape, layer by layer beginning with a bottom layer;
feeding a treatment gas into a 3-D printing device and laser-scanning a local area of the printout such that the treatment gas reacts with a surface of the local area of the printout and a hardened layer is formed,
wherein the laser-scanning a printing material and the feeding a treatment gas are performed alternately, until a printout with hardened layers are formed layer by layer, beginning with the bottom layer.

2. The 3-D printing method of claim 1, wherein the treatment gas includes ammonia.

3. The 3-D printing method of claim 2, wherein the laser-scanning of the printing material and the feeding of the treatment gas are performed alternately until the printout is formed with spaced hardened layers so that the printout has an expected hardness.

4. The 3-D printing method of claim 1, further comprising:
adjusting an internal elastic modulus and surface hardness of the printout by adjusting a volume ratio between a material layer and the hardened layers of the printout.

5. The 3-D printing method of claim 1, further comprising:
adjusting an internal elastic modulus and surface hardness of the printout by adjusting amounts and transport time of the treatment gas and a protective gas and a thicknesses of a material layer and the hardened layers.

6. The 3-D printing method of claim 1, wherein the laser-scanning includes rotary laser-scanning or local laser-scanning.

7. The 3-D printing method of claim 1, wherein a protective gas is fed into the 3-D printing device when the laser scanning of the printing material is performed, wherein the protective gas is an inert gas.

8. The 3-D printing method of claim 7, wherein the protective gas includes nitrogen or argon.

9. The 3-D printing method of claim 1, further comprising:
feeding the printing material, forming the material layer, from the 3-D printing device into a recovery cylinder to recover the printing material.

10. A 3-D printout, the 3-D printout being manufactured by the 3-D printing method of claim 1.

11. The 3-D printing method of claim 2, further comprising:
adjusting an internal elastic modulus and surface hardness of the printout by adjusting a volume ratio between a material layer and the hardened layers of the printout.

12. The 3-D printing method of claim 2, further comprising:
adjusting an internal elastic modulus and surface hardness of the printout by adjusting amounts and transport time of the treatment gas and protective gas and a thicknesses of a material layer and the hardened layers.

13. The 3-D printing method of claim 2, wherein the laser-scanning includes rotary laser-scanning or local laser-scanning.

14. The 3-D printing method of claim 3, further comprising:
adjusting an internal elastic modulus and surface hardness of the printout by adjusting a volume ratio between a material layer and the hardened layers of the printout.

15. The 3-D printing method of claim 3, further comprising:
adjusting an internal elastic modulus and surface hardness of the printout by adjusting amounts and transport time of the treatment gas and protective gas and a thicknesses of a material layer and the hardened layers.

16. The 3-D printing method of claim 3, wherein the laser-scanning includes rotary laser-scanning or local laser-scanning.

17. The 3-D printing method of claim 2, wherein a protective gas is fed into the 3-D printing device when the laser scanning of the printing material is performed, wherein the protective gas is an inert gas.

18. The 3-D printing method of claim 17, wherein the protective gas includes nitrogen or argon.

19. The 3-D printing method of claim 2, further comprising:
feeding the printing material, forming the material layer, from the 3-D printing device into a recovery cylinder to recover the printing material.

20. A 3-D printout, the 3-D printout being manufactured by the 3-D printing method of claim 2.
